(19) United States
(12) Patent Application Publication
(10) Pub. No.: US 2025/0093308 A1
(43) Pub. Date: Mar. 20, 2025

(54) MILLIFLUIDIC CHROMATOGRAPHY PLATE

(71) Applicant: Vulcan Photonics Sdn. Bhd., Kuala Lumpur (MY)

(72) Inventors: Khong Nee Koo, Pulau Pinang (MY); Farah Hidayah Binti Jamaludin, Johor (MY); Evianie Bingak Edward, Johor (MY); Mun Oon Fong, Pulai Pinang (MY)

(73) Assignee: Vulcan Photonics Sdn. Bhd., Kuala Lumpur (MY)

(21) Appl. No.: 18/707,654

(22) PCT Filed: Apr. 28, 2023
(86) PCT No.: PCT/MY2023/050030

§ 371 Date: May 6, 2024

(51) Int. Cl. G01N 30/60; G01N 30/06; G01N 30/90

(52) U.S. Cl. CPC G01N 30/6095; G01N 30/90; G01N 2030/067

(57) ABSTRACT

Chromatography plate for the separation and detection of ion selective ligands and their complexes. The combination of an enhanced chromatographic separation process with an ultraviolet imaging device for detection is developed for selective and simultaneous multiple ion sensing. The method involves the fabrication of microfluidic channels on a porous chromatographic substrate to enhance separation of ligands containing ultraviolet chromophores and their complexes with ions of interest. The chromatographic plate is analyzed under an ultraviolet imaging device to quantify the concentration of the different ions present in a sample.

### FIELD OF INVENTION

The invention relates to a chromatography plate for the separation and detection of ion selective ligands and their complexes.

### BACKGROUND

Compound separation is critical in analysing chemical compounds, as pure compounds provide reliable results without interference from other compounds, thus making chromatographic separation a useful tool in analytical chemistry. Chromatographic separation can be in the form of a simple thin layer chromatography plate to quantitatively determine the number of compounds within a solution or in the form of a complex high-performance chromatography system that can be coupled to different detectors that can determine both qualitatively and quantitatively the different compounds within a solution. The differentiating factor lies in the separation process and the mode of detection of the separated compounds.

Separation is the heart of a chromatographic process and the principle behind the separation of compounds revolves around the different interactions between the compounds present in a sample with the stationary and mobile phases of the chromatographic system. Detection on the other hand is vital to analyze the effectiveness and efficiency of the separation.

Ion sensing can be achieved with a high-performance chromatography system equipped with a specialized separation column coupled with a charge detector or a mass spectrometer. However, this method would require the sending of a sample to equipped central laboratories. While high-performance liquid chromatography coupled with a mass spectrometer is able to separate and detect ions with great precision, it is not feasible to be used in circumstances where analysis and results have to be accessed rapidly, in laboratories where such equipment are not accessible and where the cost of analysis needs to be affordable.

Hence, there is a need to develop an affordable and rapid chromatographic separation method for the separation and detection of ions that is less susceptible to interference from other ions.

An aim of the invention therefore is to provide an enhanced chromatography plate for separation and detection of ion selective ligands and their complexes that addresses the drawbacks above.

### SUMMARY OF INVENTION

In an aspect of the invention, there is provided a chromatography plate comprising:
a porous substrate;
at least one channel on the substrate wherein the channel further comprises;
a sample well for the deposition of a solution;
a ligand well for the deposition of ligands;
a mixing region to allow mixing and interaction of the solution with the ligands;
an elongated separating region for the separation of the ligands and their complexes formed; and
an effluent well where excess solution from the channel collects;

characterized in that the channel is millifluidic and the deposited ligands selectively form complexes with ions found in the solution and the mixture of ligands and their complexes then separate based on their interaction forces with the substrate along the separating region.

Advantageously the millifluidic channel provides an enhanced chromatography plate that enables equipment free chromatographic separation for ligands containing ultraviolet chromophores and their complexes in comparison to the prior art that discloses nano structured channels without the deposition of ligands that require imaging using expensive equipment to view separated compounds within the channel.

Advantageously the channel confines the flow of the solution, eliminates uneven flow patterns, enhances capillary action of the solution which in turn enhances separation of the ions found in the solution.

Advantageously spiral channels can be used to increase the number of ligands that can be separated with good resolution as straight channels are limited by the length of the chromatography plate.

Preferably the porous substrate is silica or cellulose.

In one embodiment the depth of the channel is within the range of 10 to 20 μm while the width of the channel is within the range of 1.5 mm to 3.0 mm.

In one embodiment the mixing region comprises at least two bends to enable substantial mixing of the solution with the ligands.

In one embodiment the ligands comprise ultraviolet chromophores.

In one embodiment the ligands with ultraviolet chromophores are selected from 4′-Aminobenzo-15-crown 5-Ether, 4′-Aminobenzo-18-crown 6-Ether, Diamino-benzo-9-crown-3, 4′-Aminobenzo-24-crown-8, 5,6-Benzo-4,7,13,16,21,24-hexaoxa-1,10-diazabicyclo[8.8.8]hexacos-5-ene to form complexes with cadmium, potassium, beryllium, cesium, lead and radium ions respectively.

In one embodiment the ligands with ultraviolet chromophores are selected from N,N′-Dibenzyl-4,13-diaza-18-crown 6-Ether, aza 15-crown-5, 7,16-Dibenzyl-1,4,10,13-tetraoxa-7,16-diazacyclooctadecane to form complexes with lead ions.

In one embodiment the ligands with ultraviolet chromophores are selected from Iron and 6-Thioguanine complex, Iron and 6-Amino-2-mercaptobenzothiazole complex, Iron and 4-Amino-6-hydroxy-2-mercaptopyrimidine monohydrate to form complexes with arsenic ions.

In one embodiment a single channel is fabricated to allow the deposition of multiple ligands that are selective towards different ions found in the solution to enable simultaneous separation of the ligands and complexes formed.

Advantageously the chromatography plate can help to enhance chromatographic separation by improving uniformity and resolution and allows equipment free separation of ligands and their complexes.

In one embodiment after separation, detection using an ultraviolet imaging device is performed to quantify the concentration of the different ions present in the solution.

In an aspect of the invention, there is provided a method for producing a chromatography plate comprising the steps of:
coating a chromatography plate comprising a substrate with an ultraviolet curable polymer mixture;
placing the coated plate in a vacuum chamber to remove any air bubbles;
positioning the coated plate under a liquid crystal display screen mask to enable the transfer of at least one channel design onto the coated plate when ultraviolet light is utilised to cure the polymer mixture;
washing off the uncured polymer mixture and drying the plate; and
depositing ligands selective for ions of interest in the channel formed on the plate;
characterized in that the channel is millifluidic and is fabricated to allow the deposition of multiple ligands that are selective towards different ions found within the solution to enable simultaneous separation of ligands and their complexes formed.

In an aspect of the invention, there is provided use of a chromatography plate for the separation and detection of ion selective ligands and their complexes.

### BRIEF DESCRIPTION OF DRAWINGS

It will be convenient to further describe the present invention with respect to the accompanying drawings that illustrate possible arrangements of the invention. Other arrangements of the invention are possible, and consequently the particularity of the accompanying drawings is not to be understood as superseding the generality of the preceding description of the invention.

FIG. 1 illustrates the millifluidic chromatography plate.

FIG. 2 illustrates the separation of ligands and their complexes on a straight channel millifluidic chromatography plate.

FIG. 3 illustrates the separation of ligands and their complexes on a spiral channel millifluidic chromatography plate.

FIG. 4 illustrates the method for producing the millifluidic chromatography plate.

### DETAILED DESCRIPTION

The separation component of this invention aims to enhance preferably commercially available silica or cellulose chromatography plates to create a millifluidic chromatography plate which can be used to simultaneously separate multiple ion selective ligands and their complexes with good resolution.

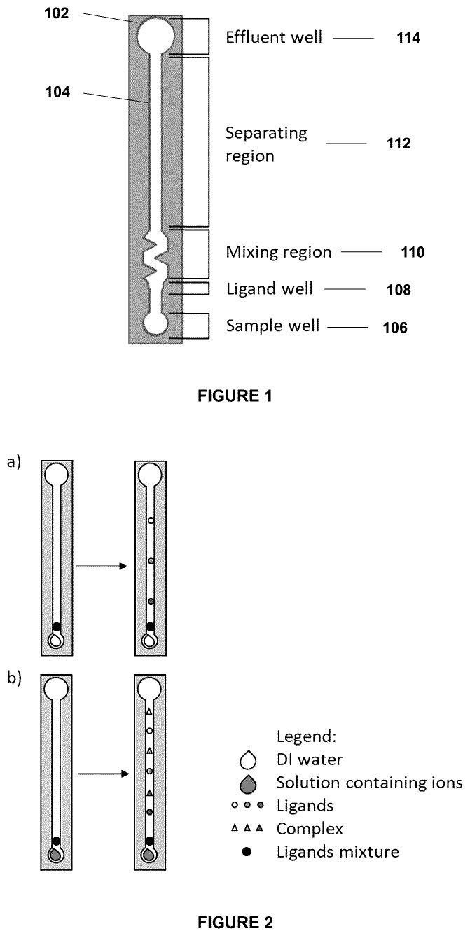

FIG. 1 illustrates the millifluidic chromatography plate of the present invention. The plate comprises a porous substrate (102) and at least one millifluidic channel (104) on the substrate wherein the porous substrate is preferably silica or cellulose. The channel further comprises a sample well (106) for the deposition of a solution, a ligand well (108) for the deposition of ligands, a mixing region (110) to allow mixing and interaction of the solution with the ligands, an elongated separating region (112) for the separation of the ligands and their complexes formed and an effluent well (114) where excess solution from the channel collects. The deposited ligands selectively form complexes with ions found in the solution and the mixture of ligands and their complexes then separate based on their interaction forces with the substrate along the separating region.

The depth of the millifluidic channel is within the range of 10-20 μm in addition to the thickness of the substrate while the width of the channel ranges between 1.5 mm to 3.0 mm. The mixing region contains at least two bends whereby the bends are at an angle of 20° to 70°, preferably 60°. The bends allow substantial mixing of the solution with the ligands, does not restrict the flow of the solution and increases the time required for the separation of the ligands and their complexes. The ligands comprise ultraviolet chromophores to enable detection of the separated ligands and their complexes using an ultraviolet imaging device. The volume of ligands deposited depends on the concentration of ions the ultraviolet imaging device is designed to detect.

FIG. 2 illustrates the separation of ligands and their complexes on a straight channel millifluidic chromatography plate. Specifically FIG. 2a illustrates the separation of ligands using a blank sample (deionised water) in comparison to FIG. 2b which illustrates the separation of ligands and their complexes using a sample solution containing ions on a millifluidic chromatography plate with a straight channel. A straight channel may be limited by the length of the chromatography plate.

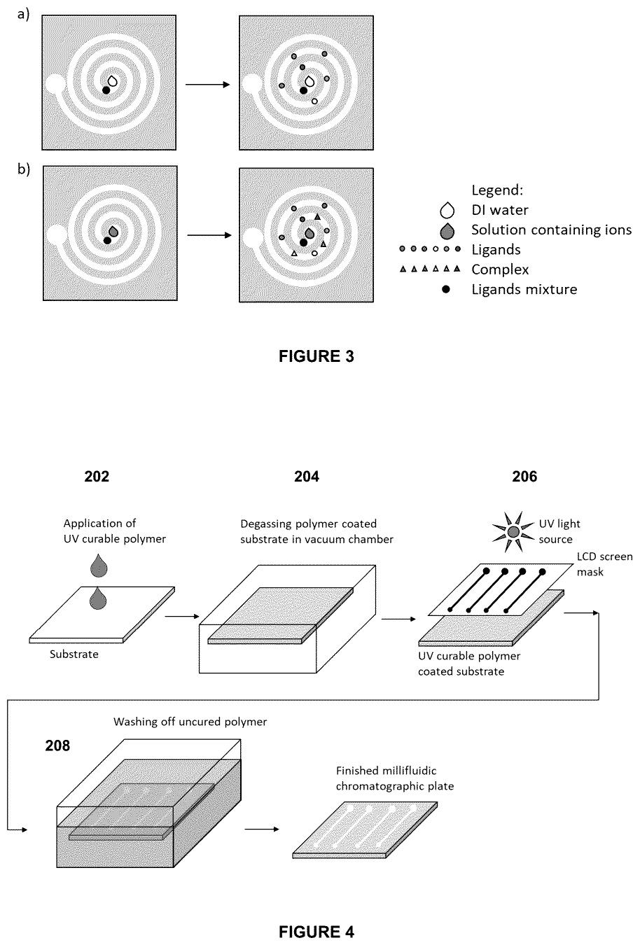

FIG. 3 illustrates the separation of ligands and their complexes on a spiral channel millifluidic chromatography plate. Specifically FIG. 3a illustrates the separation of ligands using a blank sample (deionised water) in comparison to FIG. 3b which illustrates the separation of ligands and their complexes using a sample solution containing ions on a millifluidic chromatography plate with a spiral channel. A spiral channel can be used to increase the number of ligands that can be separated with good resolution.

When a drop of solution containing ions of interest is deposited onto the sample well, the ligands will selectively bind to the respective ions they are selective to and the mixture of ligands and complexes will flow along the millifluidic channel. Once the separation on the chromatography plate is complete, the plate can be inserted into an ultraviolet imaging device, and an ultraviolet image will be captured and analysed using a proprietary software to provide a quantitative result of the ions of interest present in the solution being analysed. The detection component of the present invention is based on the use of ligands with ultraviolet chromophores that are able to absorb ultraviolet light. When the ligands and their complexes are separated using the millifluidic chromatography plate, they will appear as dark spots on the ultraviolet imaging device (after the substrate is illuminated under ultraviolet light) at different locations along the millifluidic channel relative to the strength of their interaction forces with the porous substrate; the more polar groups present on the modified ligand or its complex, the higher its interaction force with the substrate and the slower its flow along the millifluidic channel. The intensity of the dark spot will correspond to the concentration of the ligand and/or their complex in the spot. In order to identify the ligands and their complexes, the chromatography plate must first be calibrated by separating the ligands using deionized water. The relative distance from the starting point where the ligand-chromophore mixture is deposited shows the location of the ligands. Any additional dots formed when a solution is utilised instead of deionised water would correspond to the ligands' respective complex (FIGS. 2b and 3b). With a fixed amount of fluid sample being deposited on the sample well, the location of the dots should be similar and this information can be stored in a proprietary sensor system and software during calibration.

The millifluidic channel confines the flow of the solution within the channel, eliminates uneven flow patterns, enhances capillary action of the solution which in turn enhances separation of the ions found in the solution and a single millifluidic channel is fabricated to allow the deposition of multiple ligands that are selective towards different ions found within the solution to enable simultaneous separation of the ions.

The millifluidic chromatography plate of the present invention can help to enhance chromatographic separation by improving uniformity and resolution and allows equipment free separation of ligands and their complexes.

After separation, detection using an ultraviolet imaging device is performed to quantify the concentration of the different ions present in the solution.

FIG. 4 illustrates the method for producing the millifluidic chromatography plate. An ultraviolet curable polymer mixture is prepared by mixing a polymer, a crosslinker and a photoinitiator in a solvent (polymer dependent) in a polymer, crosslinker and photo-initiator to solvent ratio that results in a solution with a viscosity of 500 to 1000 cP (Table 1) to allow the polymer mixture to flow easily into the porous substrate of a commercial silica or cellulose chromatography plate.

Table 1 lists the possible combination of components for preparing the ultraviolet curable polymer mixture and the suggested mixing ratio.

TABLE 1

| | | | | Suggested mixing |
|---|---|---|---|---|
| | | | | weight ratio |
| | | | | (Polmer:Crosslinker: |
| Polymer | Crosslinker | Photoinitiator | Solvent | Photoinitiator:Solvent) |
| Sylgard 184 | Sylgard 184 | Benzophenone | Limonene | 100:10:1:30 |
| base | curing agent | | | |
| Sylgard 184 | Sylgard 184 | 1- | Limonene | 100:10:1:30 |
| base | curing agent | Hydroxycyclohexyl | | |
| | | phenyl ketone | | |
| Phenoxyethyl | Tri(propyleneglycol) | Diphenyl(2,4,6- | Isopropanol | 100:5:1:30 |
| acrylate | diacrylate | trimethylbenzoyl) | | |
| | | phosphine oxide | | |

The prepared polymer mixture is then deposited on the porous substrate ensuring the whole substrate is covered (202). The coated substrate is placed in a vacuum chamber to force any air bubbles out of the porous substrate and the polymer mixture to produce a uniform bubble-free coating (204). The coated substrate is then positioned under a liquid crystal display screen mask to enable the transfer of at least one millifluidic channel design onto the coated plate when ultraviolet light is utilised to cure the polymer mixture (206). The chromatography plate is washed in the same solvent previously utilised to prepare the polymer mixture to remove the uncured polymer mixture (208) before being dried in an oven at a temperature of 10° C. above the boiling point of the solvent utilised to prepare the polymer mixture for 30 minutes.

Selected ligands with ultraviolet chromophores specific for ions of interest (Table 2) are dissolved using a low boiling point solvent such as acetone, ethanol, isopropanol or acetonitrile and deposited at the start of the millifluidic channel. The amount of the ligands deposited depends on the sensitivity and detection range required. The millifluidic chromatography plate is utilised to analyse a solution for ions of interest by depositing a fixed amount (50-100 μL) of the solution onto the sample well of the millifluidic channel, allowing the ligands and complexes to separate along the millifluidic channel.

Table 2 lists the ligands with ultraviolet chromophores and the respective ions of interest they are selective towards.

TABLE 2

| Ligands | Ion(s) of interest |
|---|---|
| 4′-Aminobenzo-15-crown 5-Ether | Cd |
| 4′-Aminobenzo-18-crown 6-Ether | K |
| Diamino-benzo-9-crown-3 | Be |
| 4′-Aminobenzo-24-crown-8 | Cs |
| N,N′-Dibenzyl-4,13-diaza-18-crown 6-Ether | Pb |
| aza 15-crown-5 | |
| 7,16-Dibenzyl-1,4,10,13-tetraoxa-7,16-diazacyclooctadecane | |
| Iron and 6-Thioguanine complex | As |
| Iron and 6-Amino-2-mercaptobenzothiazole complex | |
| Iron and | |
| 4-Amino-6-hydroxy-2-mercaptopyrimidine monohydrate complex | |
| 5,6-Benzo-4,7,13,16,21,24-hexaoxa-1,10- | Ra |
| diazabicyclo[8.8.8]hexacos-5-ene | |

This present invention provides an enhanced chromatography plate that enables equipment free chromatographic separation for ligands containing ultraviolet chromophores and their complexes. When coupled with an ultraviolet imaging device, the present invention enables the simultaneous separation and detection of multiple ions in an aqueous environment. The present invention can be used as in-situ ion sensors which has a huge commercial value in for example water quality monitoring and point-of-care devices market.

It will be appreciated by persons skilled in the art that the present invention may also include further additional modifications made to the chromatography plate which does not affect the overall functioning of the chromatography plate.

1. A chromatography plate comprising:
a porous substrate (102); and
at least one channel (104) on the substrate wherein the channel further comprises;
a sample well (106) for the deposition of a solution;
a ligand well (108) for the deposition of ligands;
a mixing region (110) to allow mixing and interaction of the solution with the ligands;
an elongated separating region (112) for the separation of the ligands and their complexes formed; and
an effluent well (114) where excess solution from the channel collects;
characterized in that the channel is millifluidic and the deposited ligands selectively form complexes with ions found in the solution and the mixture of ligands and their complexes then separate based on their interaction forces with the substrate along the separating region.

2. The chromatography plate according to claim 1, wherein the porous substrate is preferably silica or cellulose.

3. The chromatography plate according to claim 1, wherein the depth of the channel is within the range of 10 to 20 μm while the width of the channel is within the range of 1.5 mm to 3.0 mm.

4. The chromatography plate according to claim 1, wherein the mixing region comprises at least two bends to enable substantial mixing of the solution with the ligands.

5. The chromatography plate according to claim 1, wherein the ligands comprise ultraviolet chromophores.

6. The chromatography plate according to claim 5, wherein the ligands with ultraviolet chromophores are selected from 4′-Aminobenzo-15-crown 5-Ether, 4′-Aminobenzo-18-6-Ether, Diamino-benzo-9-crown-3, 4′-Aminobenzo-24-crown-8, 5,6-Benzo-4,7,13,16,21,24-hexaoxa-1,10-diazabicyclo[8.8.8]hexacos-5-ene to form complexes with cadmium, potassium, beryllium, cesium, lead and radium ions respectively.

7. The chromatography plate according to claim 5, wherein the ligands with ultraviolet chromophores are selected from N,N′-Dibenzyl-4,13-diaza-18-crown 6-Ether, aza 15-crown-5, 7,16-Dibenzyl-1,4, 10, 13-tetraoxa-7, 16-diazacyclooctadecane to form complexes with lead ions.

8. The chromatography plate according to claim 5, wherein the ligands with ultraviolet chromophores are selected from Iron and 6-Thioguanine complex, Iron and 6-Amino-2-mercaptobenzothiazole complex, Iron and 4-Amino-6-hydroxy-2-mercaptopyrimidine monohydrate to form complexes with arsenic ions.

9. The chromatography plate according to claim 1, wherein a single channel is fabricated to allow the deposition of multiple ligands that are selective towards different ions found in the solution to enable simultaneous separation of the ligands and complexes formed.

10. The chromatography plate according to claim 1, wherein after separation, detection using an ultraviolet imaging device is performed to quantify the concentration of the different ions present in the solution.

11. A method for producing a chromatography plate according to claim 1 comprising the steps of:
coating a chromatography plate comprising a substrate with an ultraviolet curable polymer mixture (202);
placing the coated plate in a vacuum chamber to remove any air bubbles (204);
positioning the coated plate under a liquid crystal display screen mask to enable the transfer of at least one channel design onto the coated plate when ultraviolet light is utilised to cure the polymer mixture (206);
washing off the uncured polymer mixture and drying the plate (208); and
depositing ligands selective for ions of interest in the channel formed on the plate;
characterized in that the channel is millifluidic and is fabricated to allow the deposition of multiple ligands that are selective towards different ions found within a solution to enable simultaneous separation of the ligands and their complexes formed.

12. Use of a chromatography plate according to claim 1 for the separation and detection of ion selective ligands and their complexes.
